(19) United States
(12) Patent Application Publication
(10) Pub. No.: US 2026/0175508 A1
(43) Pub. Date: Jun. 25, 2026

(54) SYSTEM AND METHOD FOR BLOW MOLDING PLATE COMPONENTS FOR ARTICLES OF FOOTWEAR

(71) Applicant: NIKE, Inc., Beaverton, OR (US)

(72) Inventors: Jeremy D. Walker, Portland, OR (US); James M.F. Webster, Tigard, OR (US)

(73) Assignee: NIKE, Inc., Beaverton, OR (US)

(21) Appl. No.: 19/426,489

(22) Filed: Dec. 19, 2025

Related U.S. Application Data
(60) Provisional application No. 63/736,693, filed on Dec. 20, 2024.
(60) Provisional application No. 63/863,962, filed on Aug. 14, 2025.

(51) Int. Cl. B29C 49/22; B29C 49/04; B29C 49/20; B29L 31/50

(52) U.S. Cl. CPC B29C 49/22; B29C 49/04104; B29C 49/20; B29C 2049/2017; B29L 2031/504

(57) ABSTRACT

A blow molding system includes an extrusion system including at least one extruder configured to extrude a parison having an interior cavity and a blow pin configured to extend into the interior cavity of the parison extruded from the extrusion system. The blow molding system also includes a mold assembly at least partially defining a mold chamber configured to receive the parison. The mold chamber includes a mold surface defining a profile of a sole component of an article of footwear. The blow molding system further includes an upper opposing the mold surface and at least partially defining the mold chamber. The upper is configured with a bottom surface to receive a portion of the parison upon inflation of the parison by the blow pin.

### CROSS-REFERENCE TO RELATED APPLICATIONS

This U.S. patent application claims priority under 35 U.S.C. § 119(e) to U.S. Provisional Application No. 63/863962, filed Aug. 14, 2025 and U.S. Provisional Application No. 63/736693, filed on Dec. 20, 2024. The disclosures of these prior applications are considered part of the disclosure of this application and are hereby incorporated by reference in their entirety.

### FIELD

The present disclosure relates generally to a system for molding a sole plate for an article of footwear, and more particularly, to a system for blow molding a sole plate for direct attachment with an upper for articles of footwear.

### BACKGROUND

This section provides background information related to the present disclosure and is not necessarily prior art.

Articles of footwear conventionally include an upper and a sole structure. The upper may include any suitable material(s) to receive, secure, and support a foot on the sole structure. The upper may cooperate with laces, straps, or other fasteners to adjust the fit of the upper around the foot. A bottom portion of the upper, proximate to a bottom surface of the foot, attaches to the sole structure.

Sole structures generally include a layered arrangement extending between a ground surface and the upper. One layer of the sole structure includes an outsole that provides abrasion-resistance and traction with the ground surface. The outsole may include a sole plate formed of a rigid or semi-rigid material that provides rigidity and energy distribution across the sole structure. The sole plate may be provided with one or more types of traction elements for maximizing engagement with a ground surface. In some cases, the traction elements may be fixed to the outsole plate or integrally molded with the sole plate. Sole plates are typically manufactured using injection molding processes.

### DRAWINGS

The drawings described herein are for illustrative purposes only of selected configurations and not all possible implementations, and are not intended to limit the scope of the present disclosure.

FIG. 1 is a schematic view showing a cross section of an example configuration of a blow molding system in accordance with the principles of the present disclosure;

FIG. 2 is a schematic view showing the cross section of the blow molding system of FIG. 1, where a molding material is extruded into a mold as a parison;

FIG. 3 is a schematic view showing the cross section of the blow molding system of FIG. 1, where a mold assembly and upper are moved to a closed configuration;

FIG. 4 is a schematic view showing the cross section of the blow molding system of FIG. 1, wherein the parison is expanded into mold cavities of the mold;

FIG. 5 is a schematic view showing the cross section of the blow molding system of FIG. 1, wherein the mold assembly is moved to an open configuration for removal of the expanded parison;

FIG. 6 is a perspective view of the molded article of FIG. 5, showing a sole plate being removed from the molded article; and

FIG. 7 is a perspective view of an article of footwear equipped with a sole component according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

An aspect of the disclosure provides a blow molding system. The blow molding system includes an extrusion system including at least one extruder configured to extrude a parison having an interior cavity and a blow pin configured to extend into the interior cavity of the parison extruded from the extrusion system. The blow molding system also includes a mold assembly at least partially defining a mold chamber configured to receive the parison. The mold chamber includes a mold surface defining a profile of a sole component of an article of footwear. The blow molding system further includes an upper opposing the mold surface and at least partially defining the mold chamber. The upper is configured with a bottom surface to receive a portion of the parison upon inflation of the parison by the blow pin.

Implementations of the disclosure may include one or more of the following optional features. In some examples, the at least one extruder may include a first extruder configured to extrude a first layer of the parison and a second extruder configured to extrude a second layer of the parison concentric with the first layer. The first layer may include a first material and the second layer comprises a second material different than the first material. The first material and the second material may be selected from at least one of a polypropylene, a high-density polyethylene, a thermoplastic polyurethane, or a polyamide. Optionally, at least one of the first material and the second material may include a recycled material. In some instances, the parison may attach to the upper when the parison is inflated with a fluid from the blow pin. In some configurations, the upper may be coupled to a mold plate of the mold assembly to define at least a portion of the mold chamber. In other examples, the mold surface may define a profile for a sole plate including at least a portion of a sole plate body and a plurality of traction elements. Optionally, the at least a portion of the sole plate body may include a full-length sole plate body and the plurality of traction elements.

A sole for an article of footwear may be formed using the blow molding system. An article of footwear may include the sole plate.

Another aspect of the disclosure provides a method of forming a sole plate for an article of footwear. The method includes providing a mold chamber defined by a mold surface and an upper, the mold surface opposing the upper across the mold chamber, extruding a parison into the mold chamber, expanding the parison in the mold chamber, a material comprising the parison conforming to the mold surface and the upper, and attaching the parison to the upper within the mold chamber.

Implementations of the disclosure may include one or more of the following optional features. In some examples, extruding the parison may include extruding a first layer of the parison and a second layer of the parison concentric with the first layer. Optionally, extruding the first layer of the parison and the second layer of the parison may include continuously extruding the first layer and intermittently extruding the second layer along a length of the parison. The first layer may include a first material and the second layer may include a second material different than the first material. In some instances, the first material and the second material may be selected from at least one of a polypropylene, a high-density polyethylene, a thermoplastic polyurethane, or a polyamide. Optionally, at least one of the first material and the second material may include a recycled material.

In some configurations, the mold surface may define a profile of a sole plate of an article of footwear. In some instances, the upper may be coupled to a mold plate of the mold assembly to define the mold chamber. Optionally, the mold surface may define a profile of the sole plate including a full-length sole plate body and a plurality of traction elements. In some examples, attaching the parison to the upper may include at least one of mechanically bonding or chemically bonding a material of the parison to the upper.

The present disclosure provides a system and method for blow molding polymer components for articles of footwear, and particularly, multi-layer sole plates for articles of footwear. Conventionally, sole plates and other polymeric components of footwear are manufactured using injection molding processes, or in some instances, additive manufacturing (e.g., three-dimensional printing). While suitable, injection molding processes can be relatively costly due to the complexity of molds and molding materials. Additionally, injection molding processes may limit the types of materials that can be used, as some chemistries of materials are not compatible with each other when combined in an injection molding process. Further, these processes can be time and labor intensive. Blow molding is a low-cost and efficient manufacturing method that enables lightweight products to be manufactured that can be mono-layer or multi-layer, thereby enabling unique material combinations to be achieved in a single process. Additionally, molds associated with blow molding systems are typically less expensive relative to molds associated with injection molding processes. Use of extruded materials in a blow molding process also enables the option of incorporating recycled content or foamed layers within the center layers of a sole plate, thereby improving sustainability while maintaining desired aesthetics and performance qualities.

The details of one or more implementations of the disclosure are set forth in the accompanying drawings and the description below. Other aspects, features, and advantages will be apparent from the description, the drawings, and the claims.

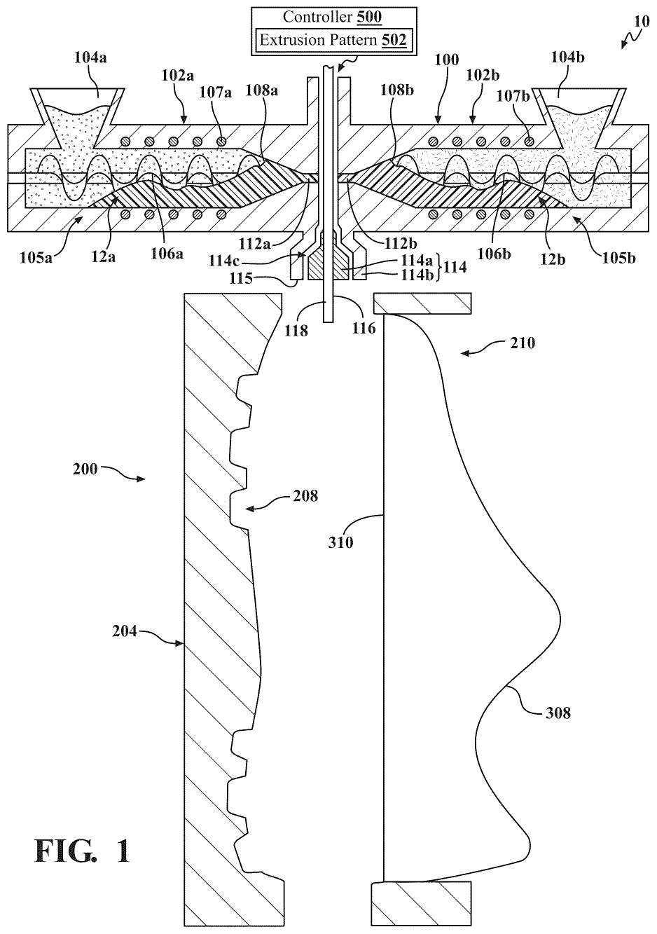

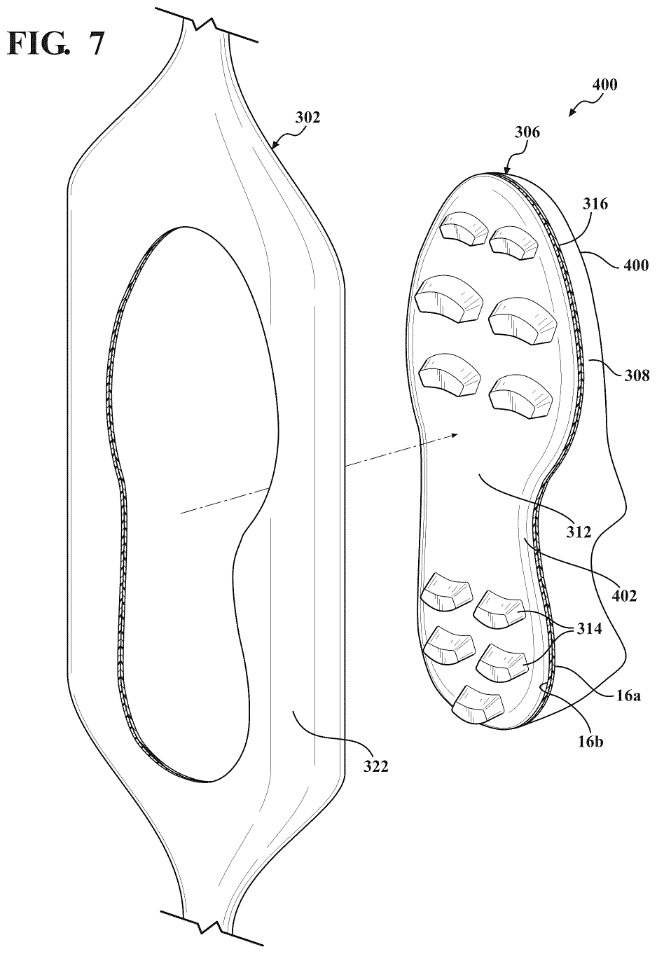

Referring to FIGS. 1-5, a blow molding system 10 is provided according to an example of the present disclosure. The blow molding system 10 includes an extrusion system 100 and a mold system 200 configured to produce a blow-molded article 300 including one or more footwear components. For example, in some configurations, the footwear components may include a sole plate 306 for use in manufacturing of an article of footwear 400 (FIG. 7). The blow molding system 10 is configured to directly attach or couple the sole plate 306 with an upper 308 of an article of footwear 400, described herein. In alternative configurations, the footwear component may include other components or portions of an article of footwear, such as heel counters, integral sole plates, integral heel counter units, or any other practicable footwear component that may be produced using the blow molding system. The extrusion system 100 may also include a controller 500 configured with a predetermined extrusion pattern 502. The controller 500 may be configured to execute one or more extruders 102a, 102b of the extrusion system 100 to, ultimately, produce the blow-molded article 300, described herein.

Referring to FIGS. 1-3, the extrusion system 100 includes the one or more extruders 102a, 102b, including a first extruder 102a configured to extrude a first mold material 12a and a second extruder 102b configured to extrude a second mold material 12b. While the illustrated example is provided with first and second extruders 102a, 102b for the sake of clarity, it should be appreciated that the extrusion system 100 may include additional extruders as desired. For example, and as discussed below, the extrusion system 100 may include a third extruder including the first material 12a or a third material and configured to extrude a third layer. In this configuration, the second material 12b may be encapsulated or interposed between the two layers of the first material 12a.

The first extruder 102a includes a first hopper 104a for receiving the first mold material 12a in a raw form, such as, but not limited to, in a pellet form, powder form, shaving form, molten form or any other practicable raw form of the first material 12a. The first extruder 102a further includes an extruder barrel 105a including a first extruder screw 106a and a heating element 107a for heating the first mold material 12a to a molten state. The extruder barrel 105a includes a first nozzle 108a disposed at an end of the first extruder screw 106a for receiving the molten first mold material 12a.

The second extruder 102b includes a second hopper 104b for receiving the second mold material 12b in a raw form, such as, but not limited to, in a pellet form, powder form, shaving form, molten form or any other practicable raw form of the second material 12b. The second extruder 102b further includes an extruder barrel 105b including a second extruder screw 106b and a heating element 107b for heating the second mold material 12b to a molten state. The extruder barrel 105b includes a second nozzle 108b disposed at an end of the second extruder screw 106b for receiving the molten second mold material 12b.

Each of the nozzles 108a, 108b of the extruders 102a, 102b may be in communication with a corresponding manifold 112a, 112b, which provide a passageway for the respective mold materials 12a, 12b to an end die 114 of the extrusion system 100. The end die 114 includes an inner portion 114a and an outer portion 114b. The inner portion 114a is received by the outer portion 114b and is moveable relative to the outer portion 114b. For example, the inner portion 114a may be attached or otherwise operably coupled to a screw or other adjustment mechanism to raise and lower the inner portion 114a relative to the outer portion 114b of the end die 114. The inner portion 114a is at least partially spaced apart from the outer portion 114b to define a gap 114c at the end die 114. The gap 114c may be selectively increased or decreased depending on the position of the inner portion 114a relative to the outer portion 114b to adjust a thickness of the mold materials 12a, 12b extruded at the end die 114.

The manifolds 112a, 112b are configured to introduce the mold materials 12a, 12b to the end die 114 in a sequential manner, whereby the first mold material 12a is provided to the end die 114 upstream of the second mold material 12b such that the second mold material 12b is layered upon an outer surface of the first mold material 12a to form layers 16a, 16b of a coextruded parison 14 including both materials 12a, 12b. In other words, the first mold material 12a forms an inner layer 16a of the parison 14 and the second mold material 12b forms an outer layer 16b of the parison 14. While the illustrated example of the extrusion system 100 is configured for coextruding two concentric layers 16a, 16b of mold materials 12a, 12b, it will be appreciated that molding systems having other configurations may be utilized. For example, the extrusion system 100 may be configured to coextrude a parison 14 including three or more tubular layers 16a, 16b. Optionally, the extrusion system 100 may be configured to extrude a parison 14 having a single layer 16a of just the first mold material 12a.

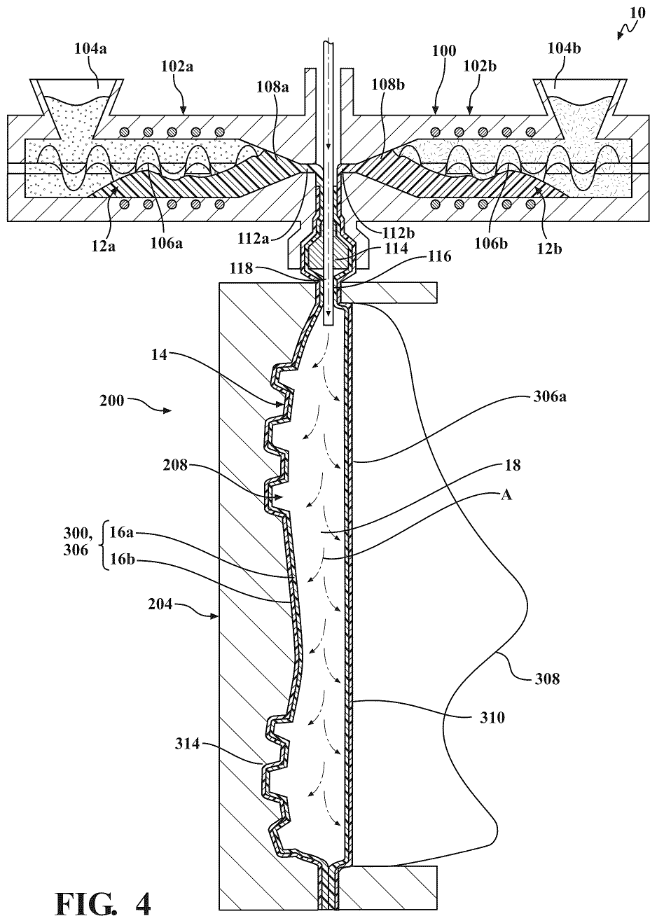

Referring still to FIGS. 1-3, the extrusion system 100 includes a blow pin 116 positioned within the end die 114 and extending from an outlet end 115 of the end die 114. The blow pin 116 is configured to extend within an interior cavity 18 of the parison 14 and into the mold system 200. While the illustrated example shows the layers 16a, 16b of the parison 14 being directly adjacent to the blow pin 116, other extrusion systems 100 may be configured such that the layers 16a, 16b of the parison 14 are spaced radially outwardly from the blow pin 116 and may be separated from the blow pin 116 by a portion of the end die 114 (e.g., an annular spacer). The blow pin 116 is configured to receive a pressurized fluid (e.g., air) and to inject the pressurized fluid into the interior cavity 18 of the parison 14 to expand the parison 14 within the mold assembly 202, as described below with respect to FIG. 4.

In some example configurations, the extrusion system 100 can be a co-extrusion system configured to produce a multi-layer parison 14. For instance, the system 100 may employ a co-extrusion head, such as a 90 mm single parison head, capable of processing multiple material layers simultaneously. This head may be configured to produce a parison with a significant number of layers, for example, seven, eight, or even more distinct layers. The extrusion system 100 can be adapted to include extruders of varying sizes to accommodate different material requirements for each layer of the parison 14. For example, a main extruder, which may be a larger extruder, could be used for a primary interior layer. Smaller extruders may be used for the inner and outer layers 16a, 16b, while other intermediate layers could be supplied by even smaller extruders. To ensure proper processing and extrusion of the various materials 12a-12c, the extruders 102a-102c may be equipped with different types of extruder screws. For many of the layers, general-purpose polyethylene (PE) screws may be suitable. However, for certain specialized layers, such as barrier layers designed to prevent material migration or provide specific mechanical properties, specialized barrier screws may be employed to ensure optimal melt quality and layer formation.

As set forth above, the extrusion system 100 is configured to coextrude first and second materials 12a, 12b. While the first and second materials 12a, 12b may be the same, an advantage of the extrusion system 100 is that it allows different materials to be coextruded as unique layers of the parison 14. The layers 16a, 16b of the parison 14 can comprise an elastomeric material that includes one or more thermoplastic polymers and/or one or more cross-linkable polymers. In an aspect, the elastomeric material can include one or more thermoplastic elastomeric materials, such as one or more thermoplastic polyurethane (TPU) copolymers, one or more ethylene-vinyl alcohol (EVOH) copolymers, and the like.

As used herein, “polyurethane” refers to a copolymer (including oligomers) that contains a urethane group (—N(C═O)O—). These polyurethanes can contain additional groups such as ester, ether, urea, allophanate, biuret, carbodiimide, oxazolidinyl, isocynaurate, uretdione, carbonate, and the like, in addition to urethane groups. In an aspect, one or more of the polyurethanes can be produced by polymerizing one or more isocyanates with one or more polyols to produce copolymer chains having (—N(C═O)O—) linkages.

Examples of suitable isocyanates for producing the polyurethane copolymer chains include diisocyanates, such as aromatic diisocyanates, aliphatic diisocyanates, and combinations thereof. Examples of suitable aromatic diisocyanates include toluene diisocyanate (TDI), TDI adducts with trimethyloylpropane (TMP), methylene diphenyl diisocyanate (MDI), xylene diisocyanate (XDI), tetramethylxylylene diisocyanate (TMXDI), hydrogenated xylene diisocyanate (HXDI), naphthalene 1,5-diisocyanate (NDI), 1,5-tetrahydronaphthalene diisocyanate, para-phenylene diisocyanate (PPDI), 3,3′-dimethyldiphenyl-4, 4′-diisocyanate (DDDI), 4,4′-dibenzyl diisocyanate (DBDI), 4-chloro-1,3-phenylene diisocyanate, and combinations thereof. In some embodiments, the copolymer chains are substantially free of aromatic groups.

In particular aspects, the polyurethane polymer chains are produced from diisocynates including HMDI, TDI, MDI, H12 aliphatics, and combinations thereof. In an aspect, the thermoplastic TPU can include polyester-based TPU, polyether-based TPU, polycaprolactone-based TPU, polycarbonate-based TPU, polysiloxane-based TPU, or combinations thereof.

In another aspect, the polymeric layers can be formed of one or more of the following: EVOH copolymers, poly(vinyl chloride), polyvinylidene polymers and copolymers (e.g., polyvinylidene chloride), polyamides (e.g., amorphous polyamides), amide-based copolymers, acrylonitrile polymers (e.g., acrylonitrile-methyl acrylate copolymers), high-density polyethylene, polyethylene terephthalate, polyether imides, polyacrylic imides, and other polymeric materials. Blends of these materials as well as with the TPU copolymers described herein and optionally including combinations of polyimides and crystalline polymers, are also suitable.

In some examples, where a first material 12a and a second material 12b are selected that are incompatible (e.g., do not naturally bond to each other in a molten state), the extrusion system 100 may include an intermediate extruder configured to extrude an intermediate adhesive material for bonding the first material 12a to the second material 12b. Thus, the parison 14 may comprise two or more layers (multilayer extrusion) joined by an adhesive. Additionally or alternatively, the extrusion system 100 may include one or more extruders configured to extrude an adhesive material adjacent to the exposed surfaces of the inner layer 16a and/or the outer layer 16b. Optionally, an adhesive layer may be extruded and applied to an exposed surface of the outer layer 16b corresponding to a ground-engaging surface of the sole plate 306 (FIG. 4), whereby the adhesive enables adhesion of one or more traction elements to the ground-engaging surface of the sole plate 306. In further configurations, the parison 14 may comprise alternating layers of one or more first copolymer materials and one or more second copolymer materials, where the total number of layers in the parison 14 includes at least four (4) layers, and/or at least ten (10) layers.

In some examples, the first material 12a or the second material 12b may include recycled or upcycled materials, which may be obtained from reclaimed scrap of prior extrusions. Recycled material is understood to be distinguishable from “virgin” materials that have never been utilized in a manufacturing process. Upcycled material is understood to be materials that are repurposed without being broken down into raw materials. In configurations utilizing a recycled or reclaimed material, the parison 14 may be formed with three or more layers 16a, 16b, including inner and outer layers 16a, 16b including virgin first material 12a or second material 12b and an intermediate layer including the recycled second material interposed between the inner and outer layers 16a, 16b. Thus, the parison 14 and the resulting sole plate 306 will include a portion of recycled material concealed between virgin material layers 16a, 16b. Thus, the resulting sole plate 306 provides the benefits of using sustainable materials while maintaining the exterior aesthetics associated with virgin materials.

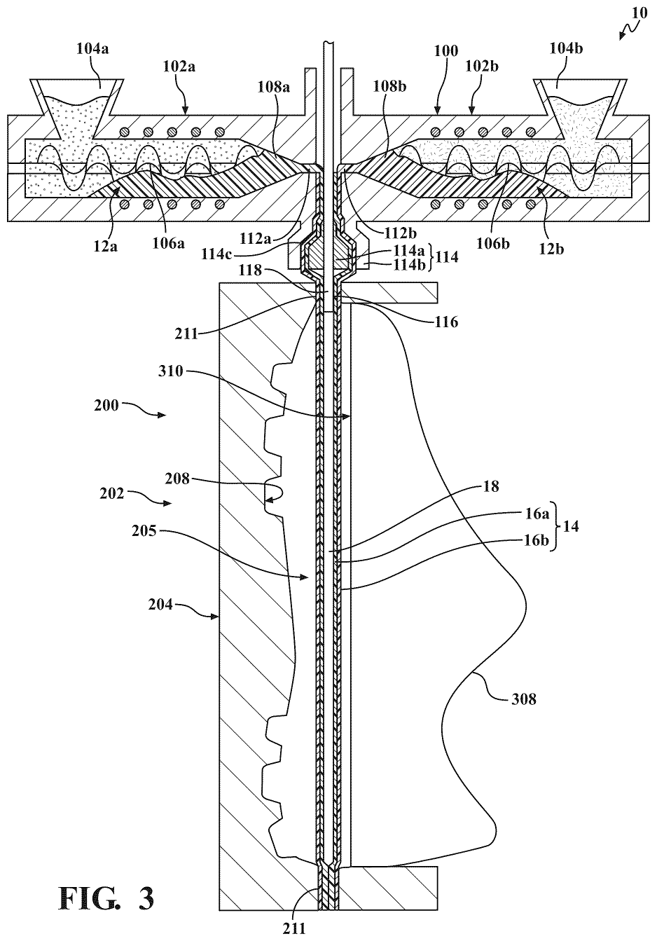

Referring to FIGS. 1-3, the blow molding system 10 further includes a mold system 200 including a mold assembly 202 and an upper 308 collectively operable between an open configuration (FIG. 1) and a closed configuration (FIG. 3). The mold assembly 202 includes a first mold plate 204 and a second mold plate 206 in which the upper 308 may be disposed. For example, the second mold plate 206 may form a peripheral frame surrounding a perimeter of the upper 308. The second mold plate 206, along with the upper 308, is configured to interface with the first mold plate 204 in the closed configuration to define a mold chamber 205 configured to receive the parison 14. The first mold plate 204 defines a mold cavity 208 corresponding to the profile of a sole plate 306 to be molded using the blow molding system 10. For example, the mold cavity 208 may define a profile of a sole component 402 (FIG. 7) of the article of footwear 400. A bottom surface 310 of the upper 308 cooperates with the second mold plate 206 to define a mold cavity 210 with the upper 308 extending from one end of the mold cavity 210 to another.

The mold plates 204, 206 are configured to interface with each other in the closed configuration (FIG. 3) to form a peripheral seal 211 around the parison 14. Thus, a peripheral portion of the parison 14 may be compressed between the mold plate 204 and the upper 308 when the mold plates 204, 206 are in the closed configuration. As shown, the mold plates 204, 206 are also configured to form a peripheral seal 211 between the blow pin 116 and the parison 14 at an entry to the mold chamber 205 to prevent fluid from escaping the mold chamber 205 during the blow molding process.

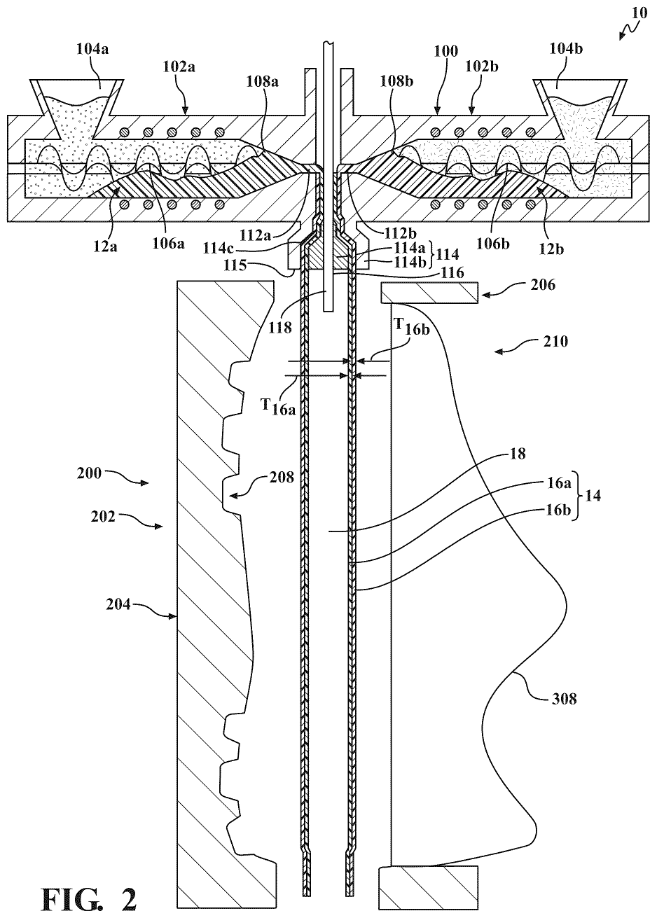

Referring to FIG. 2, a first step for forming a molded article 300 according to the present disclosure is shown. In FIG. 2, the mold assembly 202 and the upper 308 are initially provided in the open configuration, whereby the mold plate 204 and the upper 308 are spaced apart from each other to open the mold chamber 205. The extrusion system 100 extrudes the parison 14 including the one or more layers 16a, 16b of materials 12a, 12b between the mold plate 204 and the upper 308 and through the mold chamber 205. As shown, a distal end of the parison 14 extends beyond the mold chamber 205 and is aligned with ends of the mold plate 204 and the upper 308.

At FIG. 3, the mold assembly 202 is moved to the closed configuration to form the peripheral seal 211 around the parison 14. As shown, the distal end of the parison 14 is compressed between the mold plates 204, 206 to seal the interior cavity 18 at the distal end of the parison 14. Concurrently, the mold plates 204, 206 interface at a proximal end (i.e., adjacent to the end die 114) of the parison 14 to form the peripheral seal 211 around the parison 14 and the blow pin 116. Thus, at FIG. 3, the parison 14 is sealed at each of the distal end and the proximal end, whereby fluid can be introduced into the interior cavity 18 of the parison 14 via a conduit 118 of the blow pin 116 to expand the parison 14 into the first mold plate 204 and the upper 308.

At FIG. 4, compressed air A or other pressurized fluid is introduced into the interior cavity 18 of the parison 14 via the blow pin 116 to bias the layers 16a, 16b of the materials 12a, 12b of the parison 14 outwardly into the mold cavity 208 and against a bottom surface 310 of the upper 308. As shown, the mold cavity 208 of the illustrated example is configured to form a molded article 300 including a sole plate 306 having molded traction elements 314. The bottom surface 310 of the upper 308 receives the biased layers 16a, 16b as an attachment component 306a of the molded article 300, which generally conforms to the shape of the bottom surface 310 of the upper 308. The materials 12a, 12 b of the parison 14 may be at least one of mechanically bonded or chemically bonded to the upper 308 within the mold cavity 208. In so doing, the materials 12a, 12b and, thus, the molded article 300, are attached to the upper 308 within the mold cavity 208. Mechanical bonding between the materials 12a, 12b and the upper 308 may be accomplished by heating and/or sufficiently urging the materials 12a, 12b into engagement with the upper 308 such that at least one of the materials 12a, 12b is mechanically attached to a material of the upper 308. Chemical bonding may be accomplished by selecting materials of the parison 14 and materials of the upper 308 that naturally bond with one another upon the application of heat and/or pressure or upon contact between the parison 14 and the upper 308.

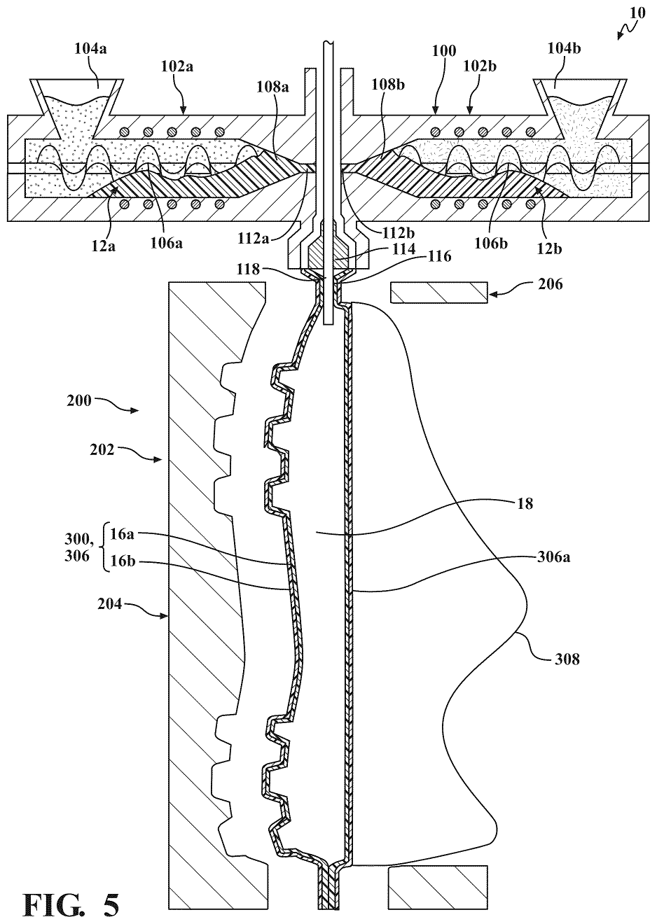

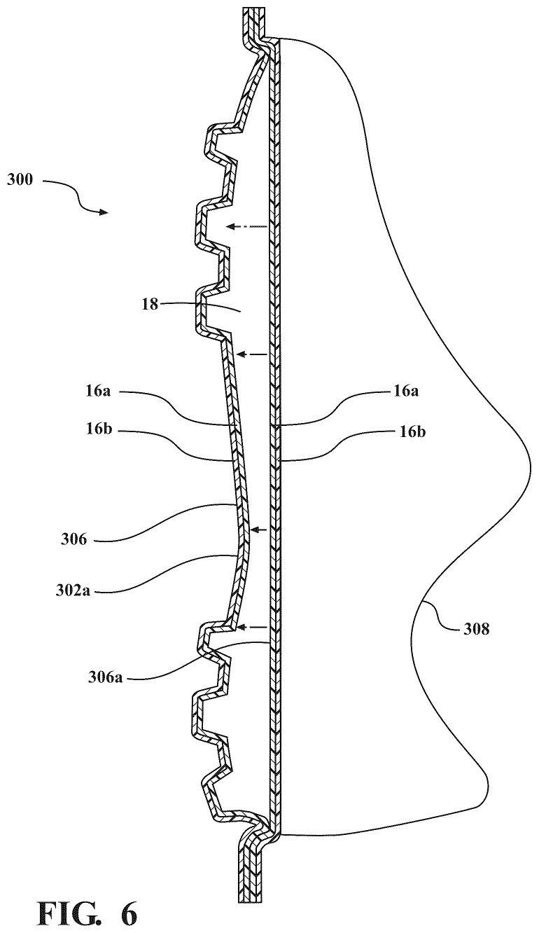

At FIG. 5, the mold assembly 202 is moved to the open configuration so that the molded article 300 including the sole plate 306 and the upper 308 can be removed from the chamber 205. At FIG. 6, prior to cooling the sole plate 306, the upper 308 and the attachment component 306a may be compressed onto the sole plate 306 to secure the upper 308 with the sole plate 306. For example, the attachment component 306a may be compressed onto the sole plate 306 to reduce the interior cavity 18 between the sole plate 306 and the upper 308. As a result, the sole plate 306 may have an increased number of layers 16a, 16b, as the layers 16a, 16b of the attachment component 306a would be joined with the layers 16a, 16b of the sole plate 306.

Referring to FIG. 7, in this step, the sole plate 306 and the upper 308 are separated from a molded casing 302 by removing mold flashing 322 from a plate body periphery 316. As shown, the sole plate 306 includes each of the layers 16a, 16b of the parison 14, which cooperate to define the structure of the sole plate 306. The illustrated sole plate 306 includes a sole plate body 312 and a plurality of traction elements 314, each including the layers 16a, 16b. A thicknesses T₁₆, T_{16b} (FIG. 2) of the layers 16a, 16b may be varied and/or the layers 16a, 16b may be intermittently provided in independent zones of the sole plate 306. FIG. 7 also illustrates the molded article 300 as a sole component 402 of the article of footwear 400, with the molded article 300 attached to the upper 308.

Referring again to FIGS. 1-7, the blow molding system 10 advantageously provides direct attachment between a sole plate 306 and an upper 308 while maintaining the structural integrity of the upper 308. For example, the upper 308 may be formed from a wide range of materials without added reinforcement to accommodate the sole plate 306. Rather, the blow molding process provides the parison 14 at a lower temperature compared to other molding processes, such that there is a reduced temperature and pressure at the upper 308 when the sole plate 306 is directly attached. While described herein as a sole plate 306, other ground-contacting features (i.e., an outsole) and/or parts of an article of footwear may be formed utilizing the blow molding system 10 described herein.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A blow molding system comprising:
a first extruder extruding a first material forming a first layer of a parison having an interior cavity;
a first mold half disposed adjacent to the first extruder and having a first mold cavity defining a profile of at least one sole component of an article of footwear;
a second mold half supporting an upper relative to the first mold half, the first mold half and the second mold half cooperating to define a mold chamber between the first mold cavity and the upper in a closed state; and
a blow pin extending into the interior cavity of the parison, the blow pin injecting pressurized fluid into the interior cavity of the parison to urge the parison into engagement with the first mold cavity and the upper.

2. The blow molding system of claim 1, further comprising a second extruder extruding a second material forming a second layer of the parison.

3. The blow molding system of claim 2, wherein the first extruder is positioned relative to the second extruder such that the first layer and the second layer are concentric.

4. The blow molding system of claim 2, wherein the first material and the second material are different.

5. The blow molding system of claim 2, wherein the first material and the second material are the same.

6. The blow molding system of claim 1, wherein the second mold half includes a mold plate supporting the upper relative to the first mold half in the closed state.

7. The blow molding system of claim 1, wherein the first mold cavity includes a plurality of recesses that define the profile of the at least one sole component.

8. The blow molding system of claim 7, wherein the recesses receive the parison when the parison is subjected to the pressurized fluid from the blow pin.

9. The blow molding system of claim 1, wherein a bottom surface of the upper opposes the first mold cavity in the closed state.

10. The blow molding system of claim 1, wherein a bottom surface of the upper receives an outer surface of the parison when the parison is subjected to the pressurized fluid from the blow pin.

11. A method comprising:
extruding a first material from a first extruder to form a first layer of a parison having an interior cavity;
positioning a first mold half adjacent to the first extruder, the first mold half having a first mold cavity defining a profile of at least one sole component of an article of footwear;
positioning a second mold half adjacent to the first mold half, the second mold half supporting a footwear upper relative to the first mold half;
defining a mold chamber between the first mold cavity and the upper when the first mold half and the second mold half are in a closed state;
extending a blow pin into the interior cavity of the parison; and
injecting pressurized fluid into the interior cavity of the parison to urge the parison into engagement with the first mold cavity and the upper.

12. The method of claim 11, further comprising extruding a second material from a second extruder to form a second layer of the parison.

13. The method of claim 12, further comprising positioning the first extruder relative to the second extruder such that the first layer and the second layer are concentric.

14. The method of claim 12, wherein extruding the first material and the second material includes extruding different materials.

15. The method of claim 12, wherein extruding the first material and the second material includes extruding the same material.

16. The method of claim 11, further comprising providing the second mold half with a mold plate supporting the upper relative to the first mold half in the closed state.

17. The method of claim 11, further comprising providing the first mold cavity with a plurality of recesses that define the profile of the at least one sole component.

18. The method of claim 17, further comprising extending the parison into the recesses when the parison is subjected to the pressurized fluid from the blow pin.

19. The method of claim 11, further comprising positioning a bottom surface of the upper in opposition to the first mold cavity in the closed state.

20. The method of claim 11, further comprising causing a bottom surface of the upper to receive an outer surface of the parison when the parison is subjected to the pressurized fluid from the blow pin.
